(19) United States
(12) Patent Application Publication
(10) Pub. No.: US 2005/0262057 A1
(43) Pub. Date: Nov. 24, 2005

(54) Intelligent data summarization and visualization

(76) Inventors: Neal B. Lesh, Cambridge, MA (US); Michael D. Mitzenmacher, Lexington, MA (US)

Correspondence Address: Patent Department;Mitsubishi Electric Research Laboratories, Inc., 201 Broadway, Cambridge, MA, 02139, US

(21) Appl. No.: 10/852,628

(22) Filed: May 24, 2004

(51) Int. Cl. G06F 7/00

(52) U.S. Cl. 707/3

(57) ABSTRACT

A query for a database is represented as a vector including multiple elements. Each element is a control, and each control has a current setting. The database is queried with the query to produce a current synopsis. The current synopsis is added to a current summary. The current synopsis and the current controls and a current summary including the current synopsis are visualized on a graphical user interface. A new setting for the controls is indicated to produce a new synopsis that when added to the current summary makes a next summary most different than the current summary. The querying, visualizing, and indicating until a termination condition is reached to generate a most interesting summary of the database.

### FIELD OF THE INVENTION

This invention relates generally to data summarization, and more particularly to visualizing summaries of multi-dimensional databases.

### BACKGROUND OF THE INVENTION

To illustrate the task of summarization, suppose a user is given access to a database storing membership records of an organization, and is asked to generate a presentation that answers the question “how old are our members?” A visualization might include a histogram showing the number of members in various age brackets.

Then, the user might want to generate some interesting variations, based on previously generated graphs. For example, a graph can show that the women in the organization are, on the average, younger than the men, and that members who live in Northwest are, on the average, older than members who live elsewhere.

In general, summarizing the age of the members of the organization would involve selecting a relatively small number of visualizations that effectively characterize the entire database.

In our terminology, each of the above graphs is a visualization of a synopsis of the database, and a collection of synopses is a summary.

A goal of the intelligent data summarization (IDS) is to quickly generate a relatively small number of these graphs that effectively characterize the entire database.

A number of methods are known for repeatedly generating and visualizing synopses, A. Buja, D. Cook, and D. Swayne, “Interactive high-dimensional data visualization,” Journal of Computational and Graphical Statistics, vol. 5, pp. 78-99, 1996. In most of those methods, the user must essentially perform an exhaustive search to visualize every potentially interesting synopsis. In the example above, the user would manually explore the data across each possible dimension, examining each combination to ensure no salient observations were missed.

It is desired to perform the exhaustive search automatically, and to inform the user whether further investigation is warranted. It is further desired to provide an informative visualization of the search.

The task of summarization is closely related to compression, machine learning, and data mining, R. Agrawal, T. Imielinsky, and A. Swami, “Mining association rules between sets of items in large databases,” Proc, of ACM SIGMOD Intl. Conf on Management of Data, pp. 207-216, 1993, and R. Agrawal and R. Srikant, “Mining Sequential Patterns,” Intl. Conf on Data Engineering, pp. 3-14, 1995.

Given that the objective is to provide a better understanding of a large database, the closest connection is to data mining.

Database Visualization

Many visualization methods and systems have been developed to help users explore and produce summaries of multi-dimensional databases. One method provides multiple, correlated views of some aspect of the database, M. Q. W. Baldonado, A. Woodruff, and A. Kuchinsky, “Guidelines for using multiple views in information visualization,” Advanced Visual Interfaces (AVI 2000), pp. 110-119, 2000. That method, as well as a more sophisticated technique called parallel coordinates, presents concurrently many different synopses to the user and lets the user identify interesting synopses or correlations, see also H. Hauser, F. Ledermann, and H. Doleisch, “Angular brushing of extended parallel coordinates, “IEEE Visualization 2002 Proceedings. IEEE Determiner Society, 2002, and A. Inselberg, “The plane with parallel coordinates,” The Visual Determiner, 1(2), pp. 69-92, 1985.

Those methods are especially effective in conjunction with brushing, which allows the user to highlight a subset of the data across multiple views, R. Becker and W. Cleaving, “Brushing scatterplots,” Technometrics, 29(2), pp. 127-142, 1987. However, unless the database is very small, presenting multiple views does not eliminate the need for manual exploration by the user.

Another method is exemplified by a visualization tool called XGobi, A. Buja, D. Cook, and D. Swayne, “Interactive high-dimensional data visualization,” Journal of Computational and Graphical Statistics, vol. 5, pp. 78-99, 1996. XGobi provides real-time, interactive control of the visualization by allowing the user to continually refine the visualization in order to search the database effectively. Additionally, XGobi employs methods, such as the use of motion, to provide information-rich visualizations to help the user spot interesting synopses for further investigation.

Data Mining

Various data mining techniques are known for finding interesting patterns and relationships in large databases. Many different notions of ‘interestingness’ have been described, R. J. Hilderman and H. J. Hamilton, “Knowledge discovery and interestingness measures: A survey,” Technical Report CS 99-04, Department of Determiner Science, University of Regina, 1999.

Association mining is a common and representative data mining task, R. Agrawal, T. Imielinsky, and A. Swami, “Mining association rules between sets of items in large databases,” Proc, of ACM SIGMOD Intl. Conf. on Management of Data, pp. 207-216, 1993. For example, an association mining task can produce rules to predict who will obtain a loan approval from a database describing applicants who were and who were not approved. For example, the following rule:
Gender=male\hat{ }age=[40-50]→status=approved, denotes that men between 40 and 50 years old tend to have loans approved. A support of this rule is the percentage of applicants in the database who are men between 40 and 50 years old. A confidence of the rule is the percentage of those records in which the loan was approved.

Often, the ‘interestingness’ of the rule is determined by comparing the confidence of the rule to an overall percentage of applicants whose loans are approved, using, for example, a chi-squared test to determine significance.

A set of rules can be presented as a directed 2D graph. In the graph, there is a node for each of the elements, e.g., gender=male, and edges representing rules connect the nodes. In a visualization, color and edge-size can be used to indicate properties of the rules, such as support or confidence, P. Kuntz, F. Fuillet, R. Lehn, and H. Briand, “A userdriven process for mining association rules,” Proc. of the 4th European Conf. of Principles of Data Mining and Knowledge Discovery, pp. 160-168, 2000.

Another approach for small rule sets is a 3D matrix, in which the antecedent and consequent of a rule determine the location of a cell, and the height or color of the cell is used to show the properties of the rule, H. Hofmann and A. Wilhelm, “Visual comparison of association rules,” Computational Statistics, 16(3), 399-415, 2001.

Blanchard, et al., provide a description of these techniques as well as their limitations for large rule sets, J. Blanchard, F. Guillet, and H. Briand, “Exploratory Visualization for Association Rule Rummaging,” Multimedia Data Mining Workshop (MDM/KDD '03), 2003. They also describe methods that represent collections of rules as spheres on top of cones in 3D ‘information landscapes’ where the properties of the rules are encoded in sphere diameter, cone height, and cone color.

Another method tracks and guides a user's exploration of a multi-dimensional database, S. Sarawagi, “User-adaptive exploration of multi-dimensional data,” Proc. of the 26th VLDB Conference, pp. 307-316, 2000. That method models the user's expectations of the unexplored parts of a datacube using a maximum entropy principle. The method guides the user to data that would most improve the ability to predict some specified dimension of the database.

Summarization Vs. Data Mining

One important distinction is that summarization involves constructing an interesting subset of synopses rather than the typical data mining task of finding a set of interesting synopses. The subtle distinction is that the prior art evaluates the quality of the individual synopses, where the invention is concerned with the quality of the entire set of synopses.

Summarization, as defined herein, involves evaluating synopses in terms of how well they inform the user about all synopses. Underlying this is an assumption about what the user infers from a summary. According to this distinction, summarization most resembles lossy compression or machine learning because the objective is to construct a compact model that best approximates a given database.

### SUMMARY OF THE INVENTION

The invention provides a method for summarizing large multi-dimensional databases intelligently. Therefore, the invention provides visualization tools to interact with a summary.

A query for the database is represented as a vector including multiple elements. Each element is a control, and each control has a current setting. The database is queried with the query to produce a current synopsis. The current synopsis is added to a current summary. The current synopsis and the current controls and a current summary including the current synopsis are visualized on a graphical user interface.

A new setting for the controls is indicated to produce a new synopsis that, when added to the current summary, makes a next summary most different than the current summary.

The querying, visualizing, and indicating are repeated until a termination condition is reached to generate a most interesting summary of the database.

### BRIEF DESCRIPTION OF THE DRAWINGS

FIG. 1A is a graph of a point statistic according to the invention;

FIG. 1B is a graph of a frequency statistic according to the invention;

FIG. 1C is a graph of a breakdown statistic according to the invention;

FIG. 1D is a pair plot statistic according to the invention;

FIG. 2 is a block diagram of a graphical user interface for visualizing summaries according to the invention;

FIG. 3 is a flow diagram of a method for summarizing and visualizing a multi-dimensional database according to the invention.

### DETAILED DESCRIPTION OF THE PREFERRED EMBODIMENT

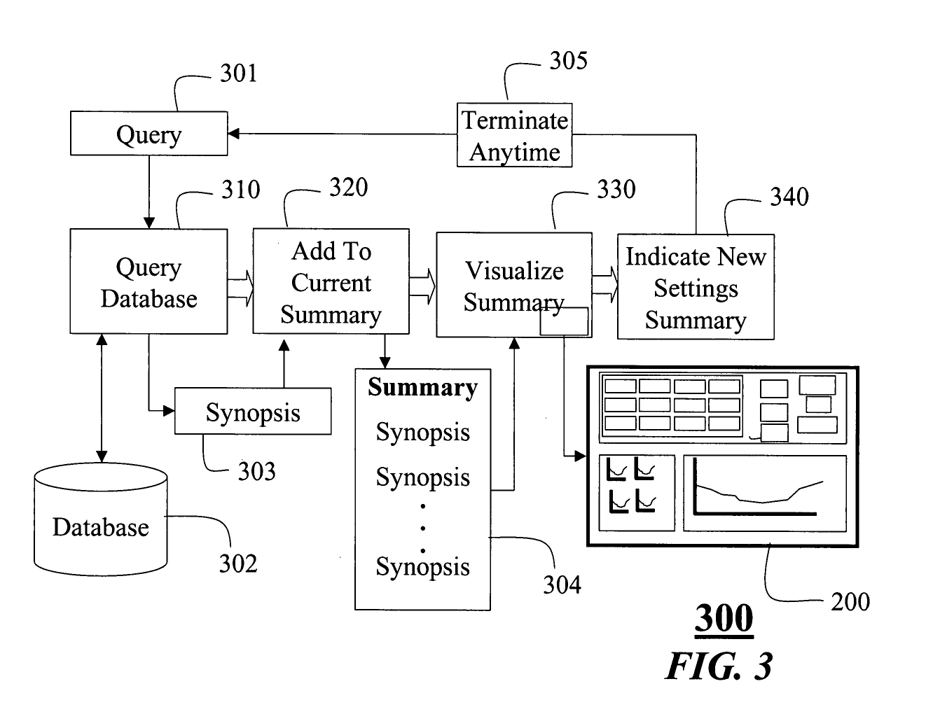

FIG. 3 shows a method 300 according to the invention for summarizing a database and visualizing a summary of the database. A query 301 for the database is represented as a vector including multiple elements. Each element is a control, and each control has a current setting.

The database 302 is queried 310 with the query 301 to produce a current synopsis 303. The current synopsis is added 320 to a current summary 304. The current synopsis and the current controls and a current summary including the current synopsis are visualized 330 on a graphical user interface 200.

A new setting for the controls is indicated 340 to produce a new synopsis that when added to the current summary makes a next summary most different than the current summary.

The querying, visualizing, and indicating repeat until a termination condition 305 is reached to generate a most interesting summary of the database.

Terminology

First, we describe a terminology and a uniform framework for summarizing, data mining and visualizing according to our invention.

At a very abstract level, a database system supports a set of queries. For each query, statistics are generated as output. More formally, a database D includes a set of pairs <q,s>m, where q is a query from a set of possible queries Q, and s is a statistic from a set of possible statistics S. We refer to query-statistic pair as a synopsis.

We describe more concrete instantiations of databases, queries, and statistics below. We are particularly interested in queries into multi-dimensional databases. For convenience, a QUERY(D, q) is a statistic that is paired with a query q into the database D.

A summary of database D is a subset of the synopses <q,s> in the database D.

A convey function is a mapping from a summary M and a query q to a statistic s. The returned statistic s is what a user who has seen a summary M should expect the query q into the database D to produce.

Ideally, we would like to produce a succinct summary M that perfectly reflects D. That is, we would find M such that:
∀qᵢ ε Q: CONVEY(M, qᵢ)=QUERY(D, qᵢ).

However, it may be impossible to perfectly summarize a database in a short summary. A weighting function W, which takes a query as input, returns a non-negative real number; the higher the number, the more ‘important’ the query.

A discrepancy function P takes a statistic produced by QUERY and a statistic produced by the convey function, and returns a difference score. The difference score is a non-negative real number indicating how different those two statistics are. A zero difference score means the statistics are identical. Positive difference scores imply dissimilarities. We are interested to find statistics that are most different than previously aggregated statistics.

It is a goal of the invention to produce multiple synopses so that each next synopsis, when added to a summary of previous synopses, generates an ‘interesting’ summary.

Summarization Problems

According to our invention, a summarization problem is defined as a tuple <D, C, W, P>, where D is a database, C is a convey function, W is a weighting function, and P is a discrepancy function.

For a particular summarization problem Z=<D,C.W.P>, and summary M, a SCORE(Z, M) is a sum of weighted discrepancies between all factual and conveyed synopses:

$${\sum }_{{q}_{1} ∈ Q} W ( {q}_{i} ) \times P ( QUERY ( D , {q}_{i} ) , C ( M , {q}_{i} ) ) . \qquad ( 1 )$$

For a summarization problem Z, summary M, and synopsis <q,s>, INTERESTINGNESS(Z, M, <q,s>) is defined as
SCORE(Z, M+<q,s>−SCORE(Z, M)).

A find-interesting-synopses (FIS) problem takes a summarization problem Z, a summary M and a threshold h, where h is a real number. The FIS problem finds all synopses with an interestingness of greater than h, with respect to the summary M.

A best-first summary for summarization problem Z is a sequence:
<q₀,s₀), . . . , <qₙ,sₙ>, for all 0≦i≦n, maximizes INTERESTINGNESS(Z, {<q₀,s₀>, . . . , <qₛ₋₁,sₛ₋₁, <qᵢ,sᵢ>}.

A maximally-summarizing-subset (MSS) problem takes a summarization problem Z and an integer k, and returns a summary M of length k that maximizes SCORE(Z, M).

Note that the FIS can model association mining. In this case, the set of queries includes all possible rules. The statistic for a query is its confidence, and possibly support. The convey function indicates that the user cannot make any inference from one synopsis to a different synopsis, except from the ‘base statistic’ produced by rules, with no restrictions on the left side. The FIS problem with a similarly restricted convey function can be used to describe an association-mining approach to discover interesting statistics of other types, such as correlations between two attributes.

While describing the MSS problem, we focus on generating the best-first summary because it is more tractable and more useful within an interactive system in which the user decides what to add next to the summary.

Database and Summaries

The invention is concerned with database that can be represented as a set of attributes aᵢ, . . . , aₙ, and a finite set of records E, where each record e specifies a value for each attribute a.

An attribute a is numeric when its value in each record e is a number, otherwise the attribute is symbolic.

Types of Statistics

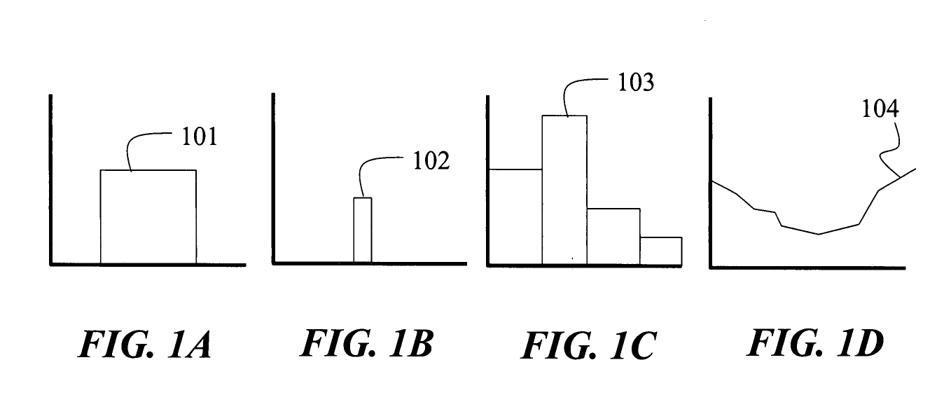

As shown in FIGS. 1A-1D, our invention supports four types of statistics.

A point statistic 101 aggregates the values of a selected numerical attribute. For example, a point statistic can describe an average or median income of some subset of people.

A frequency statistic 102 determines a percentage of values of a specified attribute that equal a specified target value. For example, a frequency statistic can indicate a percentage of loans that are approved out of a subset of loan applications. Association rules correspond directly to frequency statistics.

A breakdown statistic 103 determines a frequency for each value of a specified symbolic attribute. For example, a breakdown statistic can show the distribution of occupations over some subset of people as a histogram.

A pairplot statistic 104 determines a sequence of point statistics of a specified numerical attribute for each value of a second, specified attribute. For example, a pair plot statistic can show the average salary for each education level.

Note that both point and frequency statistics produce a single number, and that breakdown and pair plot statistics produce a sequence of pairs <x, y>, where each y is a number. Breakdown statistics can be visualized as a pie chart or a bar chart. A pair plot statistic can be visualized as a line graph or a bar chart, depending on whether the x values are numerical or symbolic.

Controls

The query 301 to the database 302 is represented as a vector. We refer to each element of the vector as a control. There are three categories of controls for our database: summary controls, aggregation controls, and data controls.

The summary controls select the type of statistic to use and specify the attributes and values necessary for that statistic. Because each summary type requires different inputs, some of the elements in the query vector are ignored based on the choice of summary type.

The aggregations control specifies the aggregation function for the point and pair plot statistics.

The data controls determine which subset of the records is used to determine statistics. There is a data control for each attribute aᵢ. The data control for a ‘region’ attribute, for example, can be used to restrict the query to only people in the Northwest. The possible settings for a data control are any subset or range of the values its attribute can have. In practice, a user interface or search process may not support all options. For example, for numeric controls, our system determines a simple histogram, which generates a fixed number of ranges, e.g. six. Each range contains roughly the same number of unique values from the database.

Convey Function

The convey function can be implemented in a number of different ways. For example, one can take a cognitive-modeling approach and try to determine what a user actually learns from a given summary. This is arguably the ‘gold standard’ because the ultimate objective is to maximize an understanding of a database. Of course, that approach is extremely ambitious and perhaps ultimately impossible because of the variance in peoples’ reactions to information.

Alternatively, one can take an information-theoretic approach and use a convey function based on minimum entropy or maximum likelihood. That approach has the advantage of precision, but will often overestimate the inference a user makes.

A preferred approach uses a very simple convey function, which makes minimal assumptions about inferences the user makes and can itself be easily conveyed to the user.

To better understand the tradeoffs, suppose the user is told that the average age of all members of an organization is forty and that one half of the records are for women whose average age is thirty. We might reasonably expect a user to conclude that the average age of men is fifty. It is perhaps overly optimistic, however, to assume that if five out of seven of the records are for women that the user will conclude that the average age for men is 65. Suppose now that the user is told that that members who live in New Jersey have an average age of forty-five. What should our convey function tell us the user will think about people who live in New York? It seems possible to expect that users will infer that their average age is slightly less than forty. Another reasonable possibility, however, is that the user infers that New York and New Jersey, being geographically near each other, would have similar members. We explicitly seek to avoid such potential confusions by informing the user about what the system will assume the user will infer.

Therefore, our preferred approach adopts a simple convey function, which assumes that people will make inferences only from synopses that are more general than a given query. For example, we expect the user would guess the average age of people in New York was forty in the above example. If asked the age of women members in New Jersey, the user would then guess forty-five, because a synopsis describing people from New Jersey is more general than women from New Jersey.

For synopses that differ only in their data control settings, we say a synopsis is as general as another if it describes a superset of the data of the other, and more general if it describes a strict superset. To predict what a summary M conveys about a synopsis p, we find the set of synopses Mᵣₑₗ ⊂ M that are as general as the synopsis p. Then, we remove any synopses in Mᵣₑₗ that are more general than another synopsis in Mᵣₑₗ.

If Mᵣₑₗ is empty, we assume the summary M conveys nothing about the synopsis p. If M contains one synopsis, then it is returned by our convey function. It is a challenge to determine what to do if Mᵣₑₗ contains multiple synopses. We combine the statistics in a simple way, e.g., by averaging. For breakdowns and pair plot statistics, we do the same for each of the values in the statistics.

Weighting and Discrepancy Functions

The weighting function can let the user indicate which attributes, combinations of attributes, or aggregation methods are most interesting. We use a simple scheme of weighting a query by the number of records matching its data-control settings. Alternatively, the weighting can be designed to measure a statistical significance.

We use a simple function to determine the difference between two point or frequency statistics, each of which is represented as a single number. We simply determine an absolute value of a difference between the value returned by QUERY and the value returned by the convey function, divided by the value returned by QUERY.

The discrepancy function for the breakdowns and pair plots are slightly more complicated because the user might be interested in, say, only where the minimum or maximum point of a plot is or whether a line plot has positive or negative slope.

Comparing Sequences

The preferred embodiment of the invention includes five ways of comparing two sequences of pairs.

We define minDiff(S₁, S₂) to be an absolute difference between the x value of the <x,y> ε S₁ with minimum y, and the x value of the <x,y> ε S₂ with minimum y.

We define maxDiff(S₁,S₂) to be an absolute difference between the x values with the maximum y values in S₁ and S₂.

We define values(S₁, S₂) to be the sum of the absolute difference for all corresponding values in S₁ and S₂, i.e., Ε|(yᵢ−yⱼ)| for all x, yᵢ and yⱼ such that <x, y> ε S₁ and <x,y> ε S₂.

We define slope(S₁, S₂) to be the sum of the absolute difference of slopes between corresponding adjacent points in S₁ and S₂ i.e., Ε(y₁−y₂)/(y₃−y₄), where (xᵢ, y₃) and hxi+1; y2i are successive points in S₁, and <xᵢ₊₁, y ₄ > are successive points in S₂.

We define trend(S₁, S₂) to be the sum of the trend-comparison between corresponding adjacent points in the statistic, where: the trend-comparison is two when one of the slopes is negative and the other is positive, one when exactly one of the slopes is zero, and zero otherwise.

We combine these functions in a single function that takes as input two sequences and five user-configurable weights pₘᵢₙ, pₘₐₓ, pᵥₐₗᵤₑₛ, pₛₗₒₚₑ, and p_{trends}, and return the sum of the five comparison functions described above times their given weight. In practice, one weight is often assigned 1.0 and the rest are assigned a weight of zero.

Anytime Method

We now describe an anytime method for finding a synopsis S=<q,s> that maximizes INTERESTINGNESS(Z, M, S) for a given summary M. That is, the method finds a next synopsis that makes the next summary most different than the current summary. By anytime, we mean that the method can be terminated at any time, and still yield reasonable results. The method can optionally be provided with a set of data or aggregation control settings to restrict the search.

For example, the user might specify that ‘region=North West’ in q. If the method runs to completion, then the method finds the optimal synopsis S that meets the user's restrictions to add to a summary M. If the method terminates early, then the method finds a good approximation to the optimal synopsis.

The method can be applied repeatedly applied to obtain a ‘best-fit’ synopsis. If at one or more stages the method is terminated early, then an approximation of the best-fit synopsis is found.

Note that an exponential number of possible synopses must be evaluated, but that even evaluating the interestingness of a single synopsis fully, according to equation (1), requires processing the synopsis against the entire, exponentially large set of queries.

Therefore, we provide a structure, which at any point in time, considers only a subset of the synopses that acts both as the candidates to add to the given summary M and the queries to sum over to approximate equation (1).

Eventually, all synopses and queries are considered. We assume that each attribute aᵢ considered by the method has a discrete set of possible values, and that the control for an attribute either restricts the attribute to a single value or allows all possible values.

That is, the only non-singleton control setting for an attribute, referred to as ‘ALL’, allows the entire set. This restriction is not necessary, but the restriction greatly improves its tractability.

The restriction corresponds to searching for only conjunctive, rather than disjunctive rules, in data mining. Similarly, if the user specifies a non-ALL value for a given control, then our method does not consider any other value for that control.

Control Tree

We use a tree structure to search all allowed combinations of settings for the controls. We maintain a separate tree for each combination of aggregate control settings, which amounts to one tree for each aggregation function that is allowed.

The tree is composed of alternating layers of query nodes (Q) and value nodes (V). Each query node corresponds to a query, or equivalently to a synopsis for a subset of the database. The root node corresponds to a synopsis (SYN) for the subset of database allowed by the given control settings if they are provided.

Each branch from a query node to a value node corresponds to one of the unrestricted data controls, which can then be constrained to obtain a new query. Each branch from a value node to a query node corresponds to one of the possible non-ALL values for the control associated with the branch leading to that value node.

There is one child for each possible value. Hence, the query nodes at the third level of the tree represent all possible queries obtained by assigning one data control a non-default value, the fifth level represents all queries obtained by assigning two data controls non-default values, and so on.

We eliminate branches to avoid redundant control settings. Thus, each possible query is represented by exactly one query node in a fully expanded tree. This framework has an advantageous interpretation in terms of the database.

Each node corresponds to a subset of the data. The root node holds all the initial data. A query node passes all of its data to each of its children, while a value node divides up its data among its children nodes, i.e., each record goes to the child whose value matches the value of attribute a in that record, where a is the attribute corresponding to the control leading to the value node. If a node contains no data, then we no longer need to expand the mode.

To calculate the obtained score for adding a synopsis S to the current summary M, we calculate SCORE(Z, M+S) by:

$${\sum }_{{q}_{i} ∈ Q} W ( {q}_{i} ) \times P ( QUERY ( D , {q}_{i} ) , C ( M + S , {q}_{i} ) ) . \qquad ( 2 )$$

Although this calculation can be done by brute force, our method starts with an empty tree and adds query nodes to a tree one at a time.

The queries corresponding to these nodes are denoted Q′⊂ Q. For each synopsis S corresponding to a query node in Q′, we track its score

$${\sum }_{{q}_{i} ∈ {Q}^{′}} W ( {q}_{i} ) \times P ( QUERY ( D , {q}_{i} ) , C ( M + S , {q}_{i} ) ) . \qquad ( 3 )$$

When Q′=Q ,we have found the score for every possible synopsis we could add to the summary. Equation (3) shows that if we stop early, our result is based on the partial set Q′ of queries instead of the full set Q, giving an effective anytime method.

At any point, the query node with the highest current score is taken to be the best possible choice to be added to the current summary. That is, we add the synopsis that is most different. There are several methods for terminating the search without fully expanding the tree. The search can be terminated after a given time limit is reached, or after the tree has been expanded to a given depth, or nodes can be pruned if their weights or, alternatively, the number of records it contains, falls below a given threshold. Our experience suggests the last option is especially useful.

The tree can be expanded in a depth-first or breath-first manner. Depth-first search utilizes memory more efficiently, but breath first search is more appealing if a time limit is used, or if the results are being displayed to the user while the process runs.

The most useful approach is likely to be some iterative deepening of the tree, which combines both types of search. We describe how to perform the calculations corresponding to equation (3) effectively.

When a query node with synopsis S is added to the tree, we need to determine the score for the summary M+S. This is calculated by brute force. But then we also need to update the score corresponding to each other synopsis S′ already currently in the tree as well, to reflect the effect adding S to Q in equation (3).

That is, if q is the query associated with S, then must consider the additional term
W(q)×P(QUERY(D, q), C(M+S′, q)), for each synopsis S′.

As nodes are added to the tree, the estimate score based on the current set of nodes Q′ can increase or decrease. When we add the query node corresponding to a second fact to the tree, the score of query node corresponding to a first fact decreases. Again, note that if the method runs to eventual completion, the correct value is determined for each summary.

If a weight corresponds to the number of records, then high weight nodes are reached early in the tree structure, suggesting that our estimated values will generally be accurate in ranking the possible summaries, even when the method terminates early.

Interactive Database Exploration

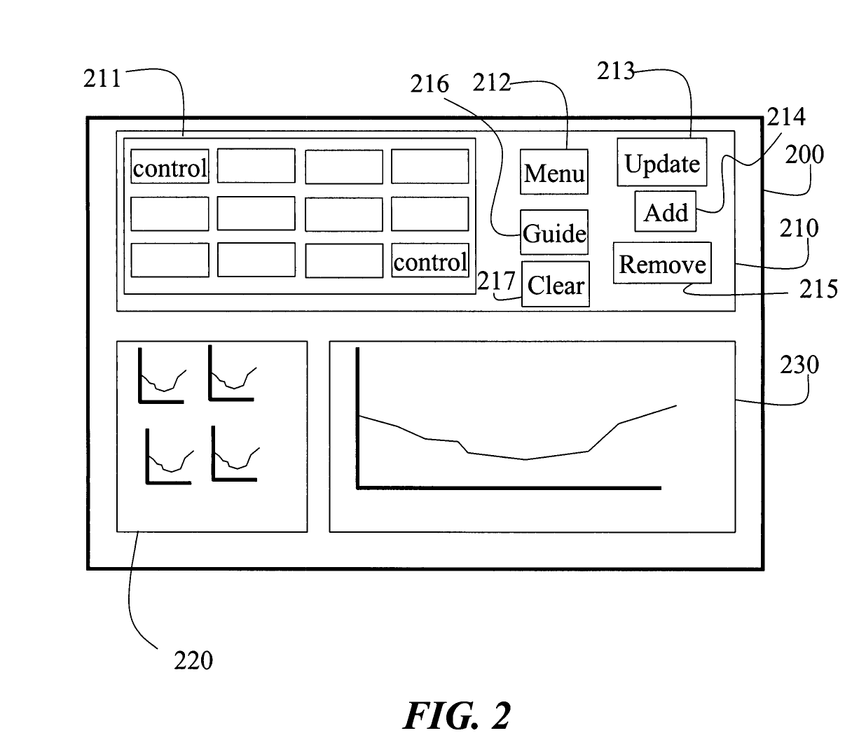

FIG. 2 shows the interactive graphical user interface 200 according to our invention.

Our visualization is meant to provide a reasonably useful data exploration tool, even without the IDS guidance, and contains some novel aspects to support summarization.

The interface 200 contains three windows, a query window 210 to represent and form and submit queries, a results window 220 displays the synopses that result from queries, and a summary window 230 is used to collect synopses of interest.

The query window contains ‘widgets’ 211 that allow the user to specify current settings for each of the controls to query the database. It also contains a menu 212 for selecting the type of statistic to use. Depending on the type of statistic, it contains menus for selecting the relevant attributes and values.

The window also contains a button labeled ‘update’ 213. The user presses this button after the controls have been updated and it is desired to resubmit the query with new control settings.

The resulting next synopsis is displayed in the results window 220. The statistic is presented in a graph, and the query is presented in the title of the graph. The summary window 230 contains the aggregation of the synopses.

Each row allows the user to set one control. The row displays the control's name followed by a set of current values for that control. The user can select or unselect the values by clicking on them. For data controls, any subset of the values can be selected. If any of the values are selected, then the selected values restrict the data to include records with a selected value for the relevant attribute.

If none of the values of a data control are selected, then no record is excluded on the basis of that control. The user can adjust the aggregation control in the same manner, except that only one value can be chosen at a time.

Each time the user selects or deselects any control value, a query is immediately submitted based on current control settings, and the resulting synopses are displayed in the result window.

The summary window holds synopses collected by the user. When the user presses an ‘Add’ button 214, the system captures the current values of all controls. A small image of the current graph or synopsis is visualized in the summary window.

If the user selects an item by clicking on it, then its control settings are restored to the query window and the appropriate synopsis is displayed in the results window. If the user presses a ‘Remove’ button 215, then the currently selected synopsis is removed from the summary window.

The query window can also contain a set of discrepancy ‘widgets’ for customizing the discrepancy function for the currently selected statistic. There is a set of parameter names associated with each type of statistic. For breakdown and pair plot statistics, for example, the parameter names are ‘values’, ‘min’, ‘max’, ‘slope’, and ‘trend’. Each discrepancy widget contains a drop-down menu with all the parameter names and a button labeled ‘Guide’ 216. The user sets the parameter values for the discrepancy function by pressing a Guide buttons. The weight of the parameter is the number of times the Guide button on the discrepancy widget with its name has been pressed. The Guide buttons are shaded to reflect its relative weight.

The user can clear all parameters by pressing a ‘Clear’ button 217. Each time the user presses the Guide button, our summarization method is run with the current control settings. First, the summarization algorithm determines the interestingness, relative to the current summary using the specified discrepancy function, of each synopsis, which could be produced by pressing any of the unselected buttons in the data and aggregation controls. These are essentially all the ‘neighbors’ of the current synopsis, i.e., ones that can be produced by making a modification to the current control settings.

The visualization then provides visual cues as to where the most interesting neighbor synopses are by shading the control buttons relative to their level of interest. Darker shades indicate more interesting synopses. For single-value statistics, such as point statistics, the button's color indicates whether the synopsis will be higher or lower than expected, e.g., red for higher, blue for lower.

After the summarization process has determined the interestingness neighbors, the process then continues its search, and dynamically maintains a list of the N most interesting non-neighbor synopses, where N is an input to the system. These synopses are represented as a shaded list of buttons.

The buttons are labeled with the queries for these synopses. As the list changes, the shading of these buttons changes to reflect their relative interestingness. Whenever the user updates the current synopsis, this re-invokes the summarization algorithm, causing new shadings to be assigned to the control buttons and the non-neighbor list to be regenerated.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

1. A method for summarizing a database and visualizing a summary of the database, comprising:
representing a query for the database as a vector including a plurality of elements, each element being a control, each control having a current setting;
querying the database with the query to produce a current synopsis;
adding the current synopsis to a current summary;
visualizing the current synopsis and the current controls and a current summary including the current synopsis;
indicating a new setting for the controls to produce a next synopsis that, when added to the current summary, makes a next summary most different than the current summary; and
repeating the querying, visualizing, and indicating until a termination condition is reached to generate a most interesting summary of the database.

2. The method of claim 1, further comprising:
determining an interestingness score for each synopsis and for each summary; and
indicating to a user the interestingness score of the synopsis that can be produced by adjusting each control.

3. The method of claim 2, further comprising:
adding the next synopsis only if the interestingness score is greater than a predetermined threshold.

4. The method of claim 2, further comprising:
generating a summary that maximizes the interestingness score for a predetermined number of synopses.

5. The method of claim 1, in which the database is multi-dimensional.

6. The method of claim 2, further comprising:
repeatedly extending a summary with the synopsis that most increases the interestingness score

7. The method of claim 1, in which the controls include summary controls, aggregation controls, and data controls.

8. The method of claim 2, in which the interestingness score is determined by how different the next synopsis is from the current synopsis.

9. The method of claim 2, in which the interestingness score is determined by how different the next synopsis from what the current summary would predict the interestingness score would be.

10. The method of claim 1, in which the interestingness score depends on an amount of data in the database that pertains to the synopsis.

11. The method of claim 1, in which the interestingness score depends on weightings provided by the user.
